(19) United States
(12) Patent Application Publication
(10) Pub. No.: US 2011/0241956 A1
(43) Pub. Date: Oct. 6, 2011

(54) CASSEGRAIN ANTENNA FOR HIGH GAIN

(75) Inventors: Woo-Jin Byun, Daejeon-city (KR); Young-Heul Cho, Daejeon-city (KR); Myung-Sun Song, Daejeon-City (KR); Bong-Su Kim, Daejeon-City (KR); Kwang-Seon Kim, Daejeon-City (KR); Min-Soo Kang, Daejeon-City (KR)

(73) Assignee: ELECTRONICS AND TELECOMMUNICATIONS RESEARCH INSTITUTE, Daejeon-city (KR)

(21) Appl. No.: 13/123,520

(22) PCT Filed: May 12, 2009
(86) PCT No.: PCT/KR2009/002485

§ 371 Date: Jun. 15, 2011

(30) Foreign Application Priority Data
Oct. 9, 2008 (KR) 1020080099342

(51) Int. Cl. H01Q 19/18

(52) U.S. Cl. 343/781 CA

(57) ABSTRACT

Provided is a high gain Cassegrain antenna. The antenna includes a feed unit that radiates radio waves, a subreflector that faces a radiation surface of the feed unit and reflects the radiated radio waves, and a main reflector that has a plurality of hole scatterers of different depths facing the subreflector and reflecting again the radio waves reflected from the subreflector. Accordingly, it is possible to manufacture a high-gain broadband antenna at low costs.

### TECHNICAL FIELD

The present invention relates to a Cassegrain antenna for high gain, and more particularly, to a Cassegrain antenna having a main reflector in which a plurality of irregularities are formed to have hole scatterers of different depths so that the antenna can operate in microwave and military wave bands.

### BACKGROUND ART

A parabolic antenna is a high-gain reflector antenna used for wireless, television, radar, and data communications. In general, the parabolic antenna has a parabolic reflector illuminated by a small feed antenna.

The reflector has a metallic surface of a parabolic shape, and the feed antenna is located at a focus of the reflector.

The parabolic reflector antenna is disadvantageous in that manufacturing costs thereof are high, and thus, it is needed to reduce the manufacturing costs by using a flat reflector antenna.

### DISCLOSURE OF INVENTION

### Technical Problem

A conventional flat reflector antenna has a kind of parabolic shape, in which a feed unit directly sends a signal to the reflector. The conventional flat reflector antenna is not suitable for wide use since the feed unit is connected to a transceiver, resulting in longer transmission lines and big losses.

There have been disclosed many patents and articles regarding a microstrip reflectarray reflector antenna in which a plurality of microstrip patches are formed on a dielectric substrate. However, although the microstrip reflectarray reflector antenna is advantageous because of its low manufacturing costs and light weight, it is disadvantageous because of reduced antenna gain caused by loss of the dielectric substrate.

### Technical Solution

The present invention provides a Cassegrain antenna in which hole scatterers of different depths are formed on a main reflector for scattering electromagnetic waves, so that the antenna may operate in microwave and military wave bands similarly to an antenna including an inexpensive main reflector of a parabolic shape or a parabolic curve shape.

### Advantageous Effects

According to the below embodiments, a Cassegrain antenna includes a main reflector having hole scatterers of different depths and a subreflector having protruding scatterers of different heights. Accordingly, it is possible to greatly reduce manufacturing costs in implementing a high-gain broadband antenna.

### DESCRIPTION OF DRAWINGS

The above and other features and advantages of the present invention will become more apparent by describing in detail exemplary embodiments thereof with reference to the attached drawings in which:

FIG. 1 is a diagram illustrating the structure of a Cassegrain antenna according to an embodiment of the present invention;

FIG. 2 is a diagram illustrating the structure of irregularities of a main reflector of a Cassegrain antenna according to an embodiment of the present invention;

FIGS. 3A through 3E are diagrams of various embodiments of a Cassegrain antenna according to the present invention;

FIG. 4 is a diagram illustrating another embodiment of a Cassegrain antenna according to the present invention;

FIGS. 5A through 5F are diagrams various embodiments of irregularities of a main reflector of a Cassegrain antenna according to the present invention;

FIG. 6 is a diagram illustrating another embodiment of a Cassegrain antenna according to the present invention;

FIG. 7 is a diagram illustrating the structure of irregularities of a main reflector of a Cassegrain antenna according to an embodiment of the present invention; and

FIG. 8 is a diagram illustrating a radiation pattern of a Cassegrain antenna according to an embodiment of the present invention.

### BEST MODE

According to an aspect of the present invention, there is provided a Cassegrain antenna including a feed unit that radiates radio waves, a subreflector that faces a radiation surface of the feed unit and reflects the radiated radio waves, and a main reflector in which a plurality of irregularities of different depths are formed to face the subreflector and to reflect again the radio waves reflected by the subreflector.

In the subreflector, protruding scatterers of different heights are formed to reflect the radio waves radiated by the feed unit toward the main reflector.

### MODE FOR INVENTION

The objectives, characteristics, and advantages of the present invention will be apparent from the following description and the accompanying drawings. In the following description, well-known functions or constructions are not described in detail if it is determined that they would obscure the invention due to unnecessary detail. Hereinafter, exemplary embodiments of the present invention will be described in detail with reference to the attached drawings.

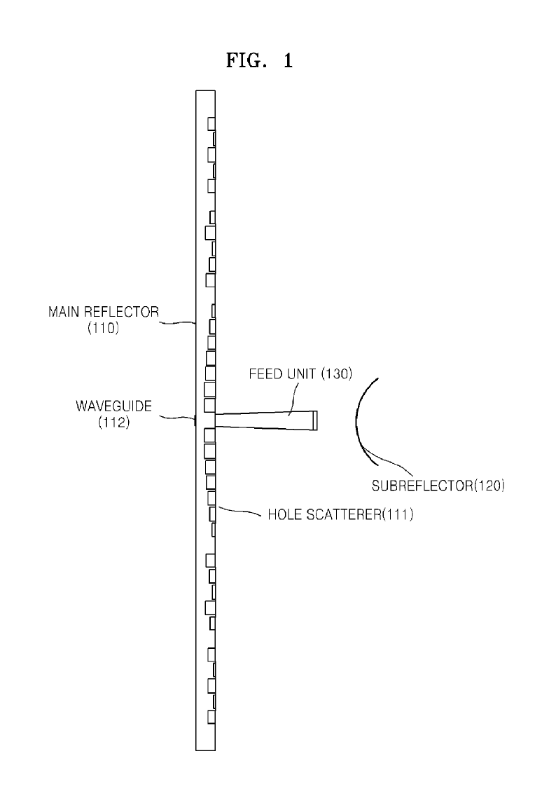

FIG. 1 is a diagram illustrating the structure of a Cassegrain antenna according to an embodiment of the present invention. Referring to FIG. 1, the Cassegrain antenna includes a main reflector 110, a subreflector 120, and a feed unit 130.

In the main reflector 110, a plurality of hole scatterers 111 of different depths are formed in a surface of the main reflector 110 facing the subreflector 120. The hole scatterers 111 scatter incident electromagnetic waves, and are formed by mechanically drilling holes in a metal plate.

The subreflector 120 is positioned to face a radiation surface of the feed unit 130 placed on the front surface of the main reflector 110, and reflects radio waves radiated from the feed unit 130 toward the main reflector 110. The subreflector 120 has the form of a curved surface of an arbitrary shape. The subreflector 120 may be formed in a hyperbolic shape.

The feed unit 130 is connected to a waveguide 112 formed in the center of the main reflector 110, and radiates radio waves toward the subreflector 120.

Electromagnetic waves reflected by the subreflector 120 and incident on the main reflector 110 are electromagnetically excited by each of the hole scatterers 111.

If the physical structure (depth, width, position, etc.) of the hole scatterers 111 is appropriately adjusted, phases of the electromagnetic waves scattered by the holes scatterers 111 may be similar to that of electromagnetic waves generated by an antenna array, so that a high gain antenna may be realized.

In this case, the hole scatterers 111 change the magnitude and phase of the electro-magnetic waves. The cross-section of each of the hole scatterers 111 may have various shapes, such as a rectangle, circle, or oval. In terms of processing cost, it is advantageous to make the cross-section of each of the hole scatterers 111 in a circular shape. Also, a high gain antenna can be obtained according to a combination of scattered waves in the hole scatterers 111. In order to obtain high gain and broadband characteristics at the same time, it is necessary to optimize the depth and shape of the hole scatterers 111.

In the current embodiment, if the depths of the hole scatterers 111 of the main reflector 110 are formed to be different from each other, a reflection array that operate in a broadband range may be obtained. A reflection array operates generally in a narrow band since the phase of the scattered electromagnetic waves varies with frequency. Accordingly, if the hole scatterers 111 in the main reflector 110 have different depths, a millimeter band antenna having high gain and broadband characteristics may be designed.

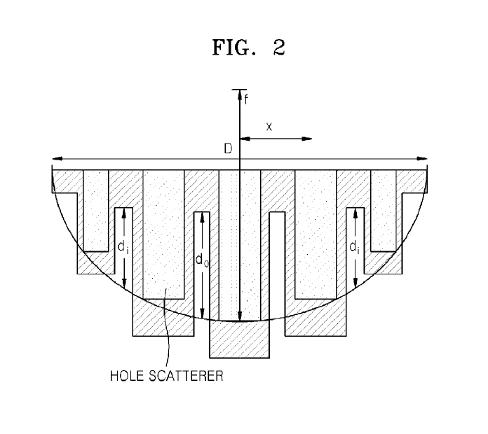

FIG. 2 is a diagram illustrating the structure of hole scatterers formed in a main reflector of a Cassegrain antenna according to an embodiment of the present invention. In FIG. 2, D denotes the diameter of a feed unit (feed antenna), xᵢ denotes the distance from the center of a main reflector to the center of the hole scatterers, f denotes the focal distance of a parabola, d₀ denotes the depth of the hole scatterer located at the center of the main reflector, dᵢ denotes the depth of the rest of the hole scatterers, and λ_{g} denotes the wavelength of an electromagnetic wave transmitted to the hole scatterers, which is determined by the width of the hole scatterers and polarization of an incident electromagnetic wave.

In general, the hole scatterers formed in the main reflector may be arranged in a parabolic shape, but they may be arranged in various curved shapes, such as a prolate spheroid shape, an oblate spheroid shape, and a spherical shape. That is, if the hole scatterers of the main reflector are formed in a parabola, prolate spheroid, oblate spheroid, hyperbola, or spherical shape, it is possible to obtain the same effect as when using a curved surface that has a parabola, prolate spheroid, oblate spheroid, hyperbola, or spherical shape.

The hole scatterers may be formed by drilling holes in a plane metal plate.

Narrower intervals between the hole scatterers enable a higher gain. In general, an interval between adjacent hole scatterers of the main reflector is set to be narrower than the width of each of the hole scatterers of the main reflector, but it is necessary to appropriately determine an interval in consideration of process costs and errors.

Also, the widths of the hole scatterers may be smaller than λ_{g}/2, so that electro-magnetic waves transmitted to the hole scatterers may be in a single mode.

The depth dᵢ may be determined in consideration of the geometrical structure of the hole scatterers and the feed antenna characteristic f/D, as follows:

$${d}_{i} = {d}_{0} - \frac{1}{4 f} {x}_{i}^{2} \qquad [ Math . 1 ]$$

When the depth dᵢ is greater than λ_{g}/2, it may be adjusted to be always less than λ_{g}/2 according to the transmission line theory. Because a period of time of a reflection wave is λ_{g}/2, the depth d may be determined not to be greater than λ_{g}/2 by calculating dᵢ-λ_{g}/2.

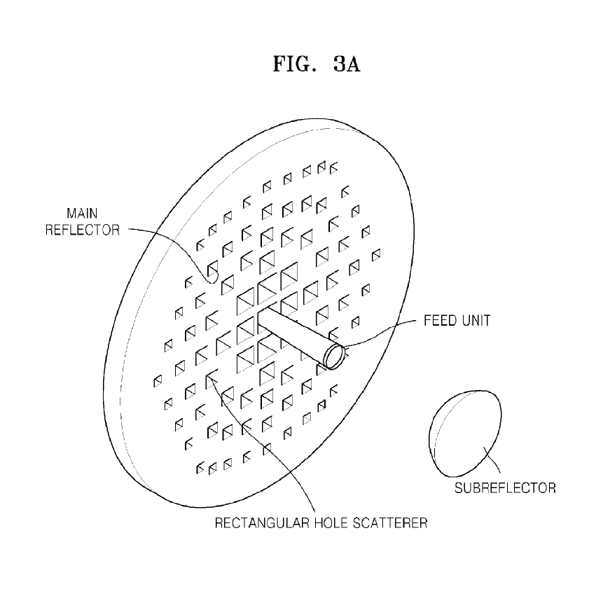

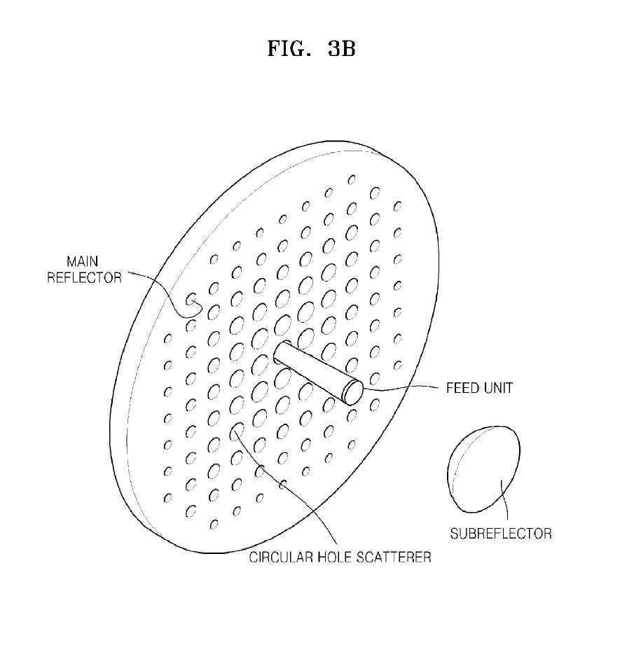

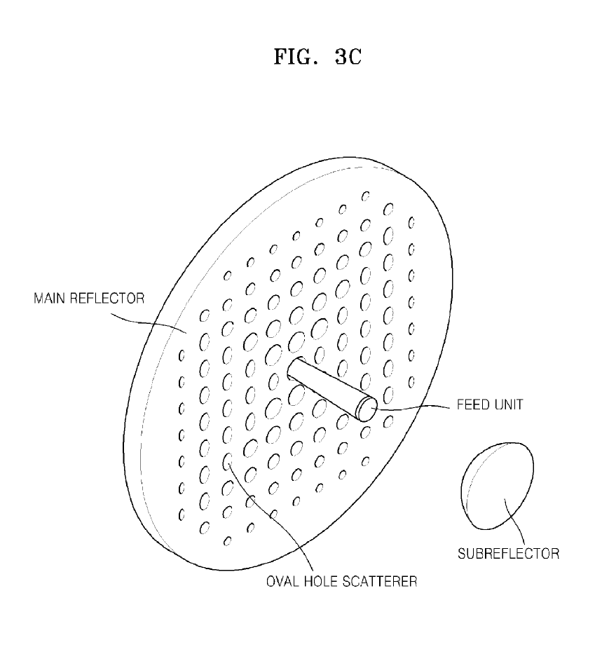

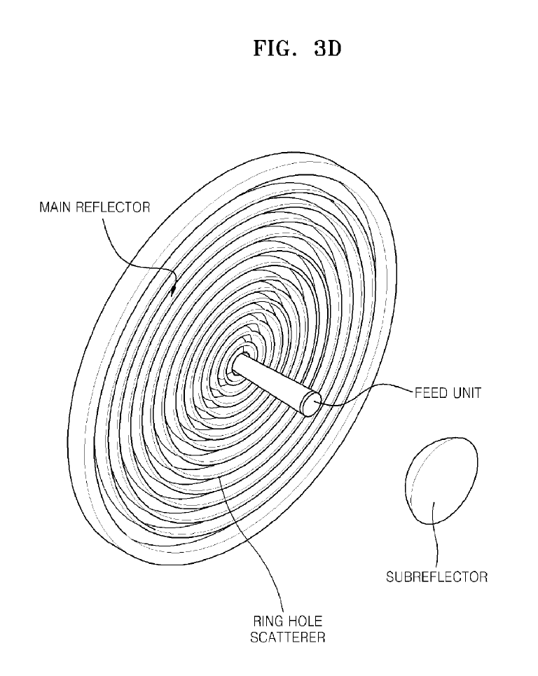

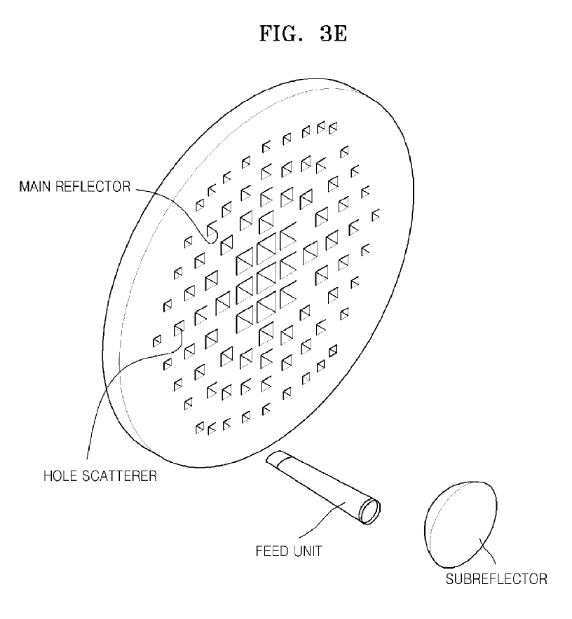

FIGS. 3A through 3E are diagrams illustrating various embodiments of a Cassegrain antenna according to the present invention. Referring to FIGS. 3A to 3D, hole scatterers in a main reflector of a Cassegrain antennas have a rectangular, circular, oval shape or ring shape. FIG. 3E is a diagram illustrating a Cassegrain antenna using a feed unit that is located to be spaced apart from a portion of an area between a main reflector and a subreflector, through which radio waves reflected from the subreflector and radio waves reflected again from the main reflector travel.

In the above embodiments of FIGS. 3A through 3E, the locations of the main reflector, the subreflector, and the feed unit may be adjusted and changed according to the phase of a radio wave which is to be finally reflected on the main reflector.

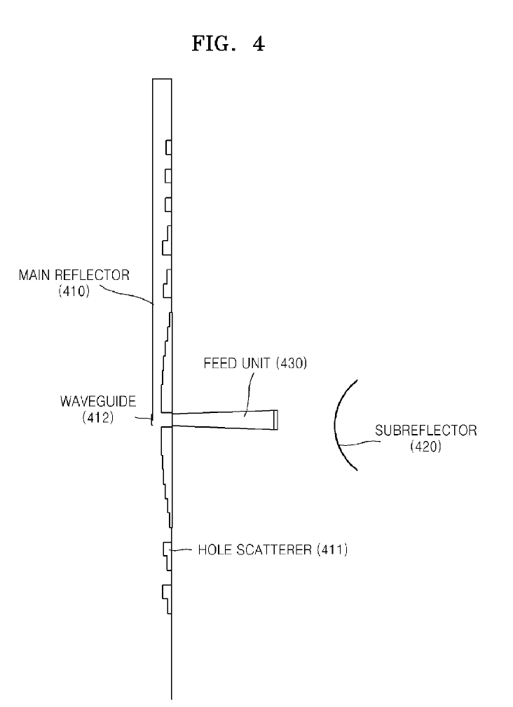

FIG. 4 is a diagram illustrating another embodiment of a Cassegrain antenna according to the present invention. Referring to FIG. 4, in the Cassegrain antenna, hole scatterers 411, are formed in a main reflector 410 not to be spaced from each other, i.e., they are closely adjacent to each other. That is, high gain may be obtained by maximizing the area of the hole scatterers 411.

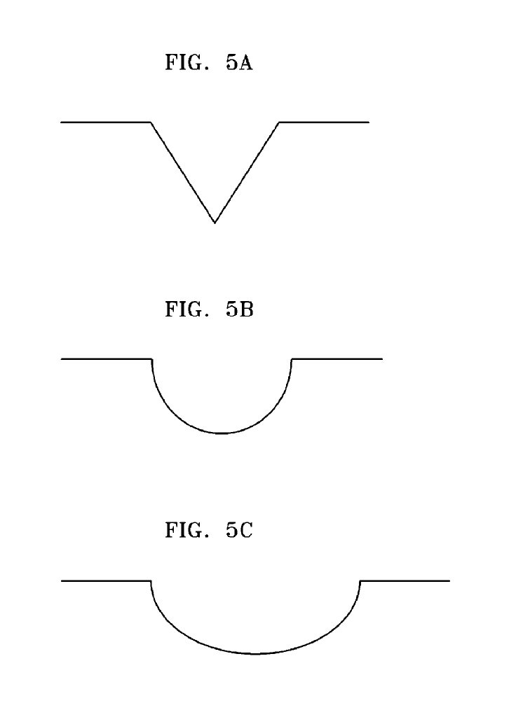

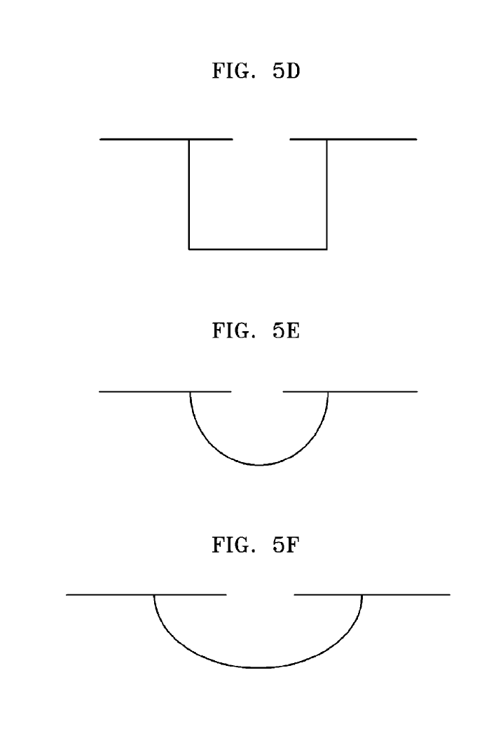

FIGS. 5A through 5F are diagrams illustrating various embodiments of hole scatterers of a main reflector of a Cassegrain antenna according to the present invention. Referring to FIGS. 5A to 5C, the aperture surfaces of the hole scatterers have a triangular, circular, or oval shape. Referring to FIGS. 5D through 5F, a slot is formed in an area of the upper surface of a main reflector corresponding to the hole scatterers so that aperture surfaces of the hole scatterers are narrower than bottom surfaces of the hole scatterers when the aperture surfaces of the hole scatterers have a rectangular, circular or oval shape. These embodiments are designed to improve the bandwidth and gain characteristics of the antenna by adjusting at least one of the magnitude and phase of a radio wave reflected via the hole scatterers.

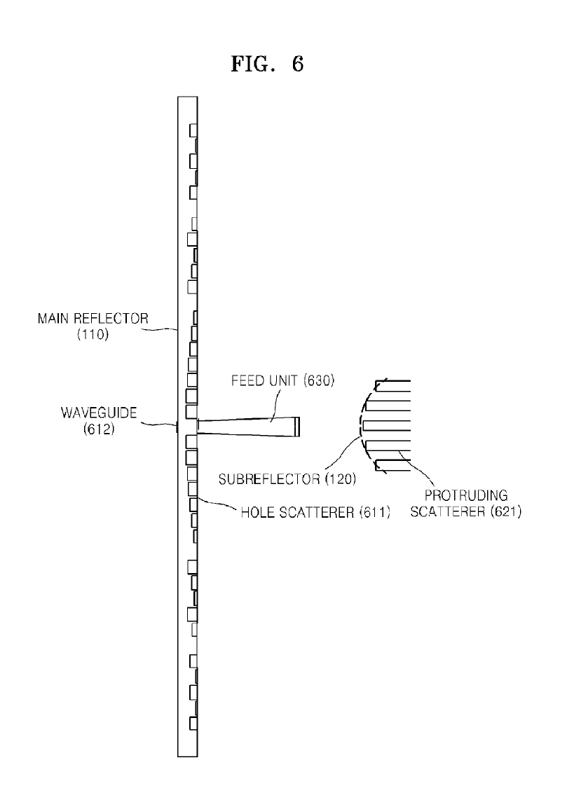

FIG. 6 is a diagram illustrating another embodiment of a Cassegrain antenna according to the present invention. Referring to FIG. 6, in the Cassegrain antenna, the shapes of a main reflector 610 and the a feed unit 630 are the same as those illustrated in FIG. 1, but a subreflector 620 is formed to have protruding scatterers 621 of different heights facing the feed unit 630. In the current embodiment, the protruding scatterers 621 are formed in an arbitrary curved shape. That is, it is possible to obtain the same effect as when using a subreflector in a curved shape, such as a spheroid, oblate spheroid, hyperbolic or spherical shape.

Also, the protruding scatterers 621 may have various shapes, e.g., a circular or oval shape other than a rectangular shape.

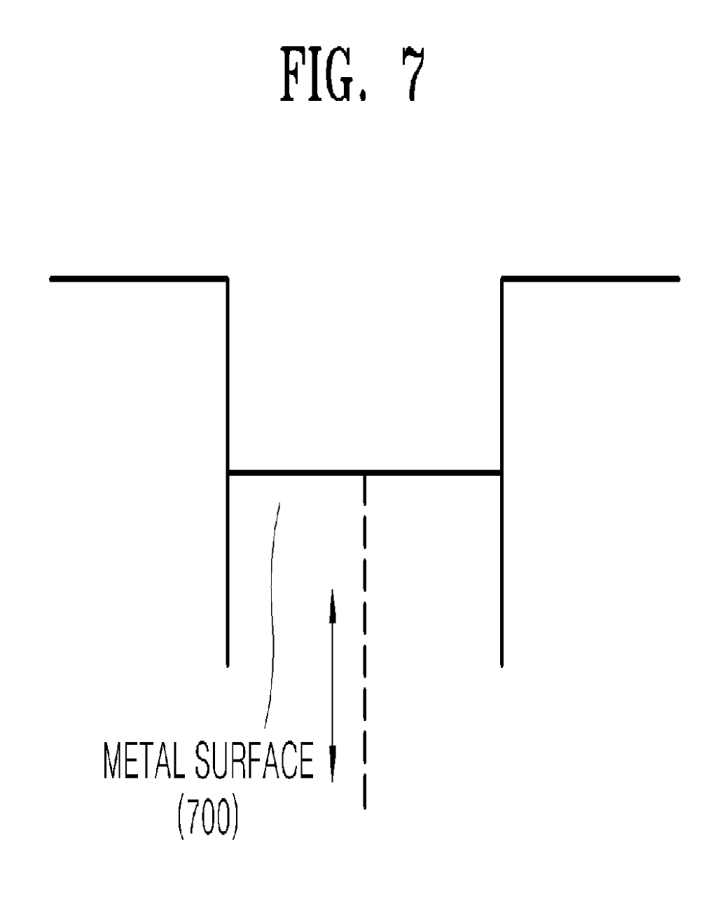

FIG. 7 is a diagram illustrating the structure of the hole scatterers of a main reflector of a Cassegrain antenna according to an embodiment of the present invention. Referring to FIG. 7, a surface 700 of a metal material is installed in the bottom area of the hole scatterers to be moved upward and downward. Thus, the depth of the hole scatterers may be adjusted to change at least one of the magnitude and phase of a radio wave reflected by the hole scatterers. Also, a beam may be formed in an arbitrary direction.

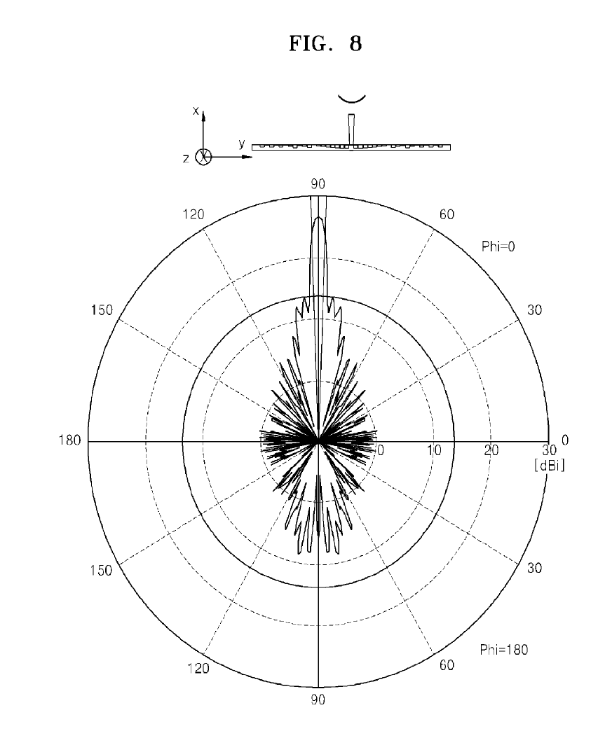

FIG. 8 is a diagram illustrating a radiation pattern of a Cassegrain antenna according to an embodiment of the present invention. That is, FIG. 8 illustrates X-Z radiation characteristic of a Cassegrain antenna having a main reflector including hole scatterers. In the current embodiment, a measured frequency is 70 GHz. Referring to FIG. 8, the radiation characteristic of the antenna is well directed in the positive x direction.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A Cassegrain antenna comprising:
a feed unit radiating radio waves;
a subreflector facing a radiation surface of the feed unit and reflecting the radiated radio waves; and
a main reflector having a plurality of hole scatterers of different depths facing the subreflector, and reflecting again the radio waves reflected on the subreflector.

2. The antenna of claim 1, wherein at least some of hole scatterers) form a curved shape, where the curved shape is a parabola shape, a prolate spheroid shape, an oblate spheroid shape, and a spherical shape.

3. The antenna of claim 1, wherein the hole scatterers of the main reflector are formed by drilling holes in a plane plate.

4. The antenna of claim 1, wherein aperture surfaces of the concave parts of the irregularities of the main reflector have a rectangular, circular, or oval shape.

5. The antenna of claim 1, wherein intervals between at least one of hole scatterers of the main reflector are less than a width of the at least one of hole scatterers

6. The antenna of claim 1, wherein a slot is formed in an area of an upper surface of the main reflector corresponding to the hole scatterers so that aperture surfaces of the hole scatterers are narrower than bottom surfaces of the hole scatterers.

7. The antenna of claim 1, wherein at least one of magnitude and phase of the radio waves which are reflected again is adjusted by adjusting the depths of the hole scatterers of the main reflector

8. The antenna of claim 1, wherein the bottom surface of each of the hole scatterers of the main reflector is formed to be moved upward or downward.

9. The antenna of claim 1, wherein the feed unit is connected to a waveguide formed in the center of the main reflector.

10. The antenna of claim 1, wherein the feed unit is located to be spaced apart from a portion of a region between the main reflector and the subreflector, through which the radio waves reflected from the subreflector and the radio waves reflected again from the main reflector pass.

11. The antenna of claim 1, wherein a surface of the sub reflector, from which the radio waves are reflected, has a curved shape, where the curved shape is one of a parabola, a prolate spheroid, an oblate spheroid, a hyperbolic shape and a spherical shape.

12. The antenna of claim 1, wherein the subreflector has a plurality of protruding scatterers of different heights that reflect the radiated radio waves to the main reflector.

13. The antenna of claim 12, wherein the protruding scatterers of the subreflector form a curved surface, where the curved shape is one of a parabola, a prolate spheroid, an oblate spheroid, a hyperbolic shape and a spherical shape.
